(19) United States
(12) Patent Application Publication
(10) Pub. No.: US 2008/0161066 A1
(43) Pub. Date: Jul. 3, 2008

(54) System and method for wireless communication

(75) Inventors: Kenneth John Reda, San Juan Capistrano, CA (US); Jean Louis Domerego, Irvine, CA (US)

Correspondence Address: CROWELL & MORING LLP;INTELLECTUAL PROPERTY GROUP, P.O. BOX 14300, WASHINGTON, DC, 20044-4300, US

(73) Assignee: Seamless Wi-Fi, Inc., Las Vegas, NV (US)

(21) Appl. No.: 11/649,404

(22) Filed: Jan. 3, 2007

(51) Int. Cl. H04M 1/00

(52) U.S. Cl. 455/569.1

(57) ABSTRACT

A wireless communication system includes a cellular-capable device, a wireless headset and a wireless dialer. The wireless dialer is usable to establish a first wireless connection with the wireless headset, while the wireless headset is configured to establish a separate second wireless connection with a cellular-capable device. In one embodiment, the wireless dialer is configured to receive user communication data and to provide this data to the wireless headset over the first wireless connection. The wireless headset may then transmit this user communication data over the second wireless connection to the cellular-capable device.

### FIELD OF THE INVENTION

The invention relates in general to wireless communication and in particular to improving cellular communication using a wireless system and method.

### BACKGROUND OF THE INVENTION

Personal wireless communication technologies are rapidly being developed worldwide. Many of these technologies are based on the Bluetooth™ wireless technology developed by Ericsson Corporation in Sweden. Such technologies have enabled the widespread adoption of convenient mobile services at relatively low cost. Bluetooth™ is an industrial specification for wireless personal area networks (PANs) and provides a convenient way to connect and exchange information between devices such as mobile phones, laptops, PCs, printers and digital cameras via a relatively secure, globally unlicensed short-range radio frequency. Typically, Bluetooth™-enabled devices communicate over a distance of approximately 10 meters and have the ability to transmit both voice and data signals over a wireless link. Bluetooth™-enabled devices have included laptop computers, cellular telephones, personal digital assistants (PDAs), earpiece/headset devices and so on.

With respect to wireless headsets or earpieces which have been “paired” with a cellular device (e.g., smartphones, cellular telephones, etc.), users are able to engage in two-way communication with a third party without having to handle the cellular device itself. This convenience is particularly useful when the cellular device isn't immediately accessible, while the user is driving a vehicle, or while the user is otherwise engaged in an activity which requires the user to have two free hands. However, all such wireless headsets and earpieces heretofore have suffered from various drawbacks which impede the overall convenience of the device. For example, the cellular device must be physically handled by the user in order to place calls to all non-programmed numbers. While voice command dialing may be possible using just the wireless headset, this functionality is only applicable in the limited context of preprogrammed telephone numbers. In cases where the cellular device is inaccessible or bulky, this can be a significant inconvenience for the user.

Additionally, wireless headsets have heretofore not be designed to optimize both cellular communications as well as music listening functions. Thus, what is needed is a system and method which overcomes one or more of the aforementioned drawbacks.

### SUMMARY OF THE INVENTION

Disclosed and claimed herein is a system and method for wireless communication. In one embodiment, the system includes a cellular-capable device, a wireless headset configured to establish a first wireless connection with the cellular-capable device, and a wireless dialer configured to receive user communication data and to establish a second wireless connection with the wireless headset. The system further comprises transmitting the user communication data from the wireless dialer to the wireless headset using the second wireless connection, and transmitting the user communication data to the cellular-capable device from the wireless headset using the first wireless connection.

Other aspects, features, and techniques of the invention will be apparent to one skilled in the relevant art in view of the following detailed description of the example embodiments of the invention.

### BRIEF DESCRIPTION OF THE DRAWINGS

FIG. 1A is a block diagram of a wireless headset designed in accordance with one embodiment of the invention;

FIGS. 1B-1C depict two views of the wireless headset of FIG. 1A;

FIG. 2 is one embodiment of a block diagram for a system which incorporates one or more aspects of the invention;

FIGS. 3A-3B depicts two views of a wireless dialer usable in the system of FIG. 2; and

FIG. 4 is one embodiment of a process for carrying out certain aspects of the invention.

### DETAILED DESCRIPTION OF THE EXEMPLARY EMBODIMENTS

The present disclosure relates in part to a system for wireless communication which includes a cellular-capable device, a wireless headset and a wireless dialer. In certain embodiments, the wireless dialer may establish a first wireless connection with the wireless headset, while the wireless headset may be configured to establish a separate second wireless connection with a cellular-capable device. In one embodiment, the wireless dialer may be configured to receive user communication data and to provide this data to the wireless headset over the first wireless connection. The wireless headset may then transmit this user communication data over the second wireless connection to the cellular-capable device.

In certain embodiments, the cellular-capable device may be any one of a cellular telephone, smartphone, personal digital assistant and a cellular-capable computer. In addition, a wireless headset of the present disclosure may be configured as a single-ear headset and may include a first earbud for positioning adjacent to a first user ear. The wireless headset may further include a second earbud affixed to the headset on a retractable connection line, where the second earbud is configured for positioning adjacent to a second user ear.

Another aspect of the disclosure is a wireless dialer includes a display and a keypad for entering the aforementioned user communication data. In one embodiment, the user communication data includes a called party telephone number.

In certain embodiments of the wireless headset, the headset may be further configured to receive a media data stream from the cellular-capable device over the first wireless connection. This media data stream may comprise a music stream. In certain embodiments, the media data stream may be automatically halted in response to an incoming call signal from the cellular-capable device.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein, the term “Bluetooth™ module” refers to software and/or hardware configured to provide wireless communication between devices in accordance with the Bluetooth™ standard. Bluetooth™ is a trademark registered and refers to technology developed by an industry consortium known as the Bluetooth™ Special Interest Group. Bluetooth™ operates at a frequency of approximately 2.45 GHz, utilizes a frequency hopping (on a plurality of frequencies) spread spectrum scheme.

A control interface is typically defined between two or more Bluetooth™ modules using a passkey, for example. This process is commonly referred to as “pairing.” Once two or more devices have been “paired,” message packets associated with the prescribed interfaces are communicated freely between the corresponding Bluetooth™ modules. Additional details on the functionality of Bluetooth™ modules are readily known in the art and are beyond the scope of this disclosure.

While aspects of the present disclosure may relate to Bluetooth™ communication, it should equally be appreciated that any other known RF communication protocol could similarly be used consistently with the principles of the invention. As such, where reference is made to Bluetooth™ communications and/or modules, it should be appreciated that any other RF communication protocols may be substituted in lieu thereof.

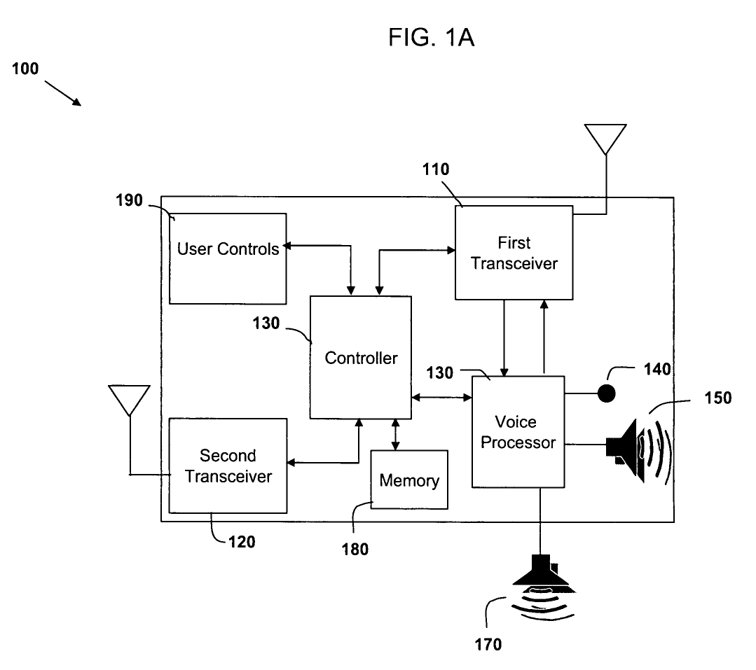

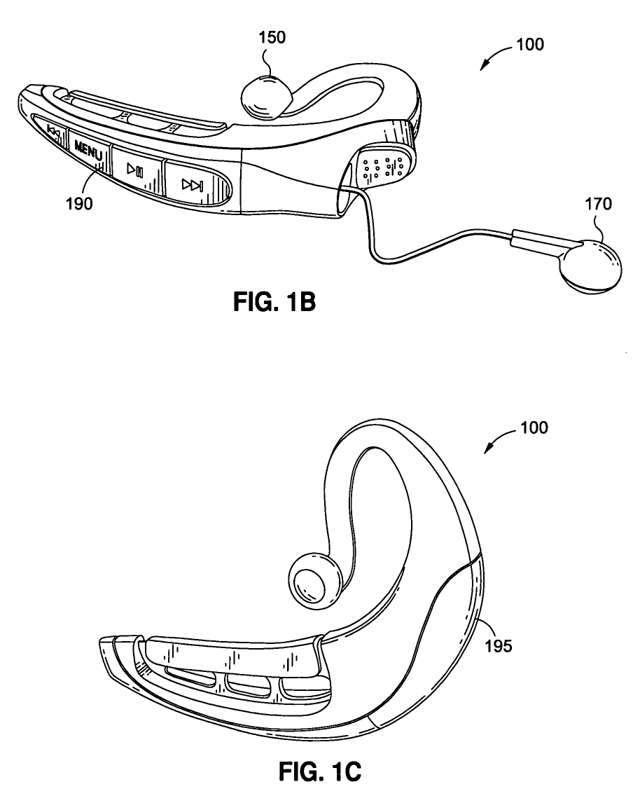

FIG. 1A is a block diagram a wireless headset 100 according to one embodiment of the invention. In one embodiment, headset 100 is configured as an earpiece. Headset 100 includes at least a first transceiver 110 and a second transceiver 120, both electrically coupled to and controlled by controller 130. While in one embodiment, both the first transceiver 110 and second transceiver 120 are RF transceivers, either may alternatively be an infrared transceiver. Moreover, one or both of the first transceiver 110 and second transceiver 120 may incorporate a Bluetooth™ module so as to enable communication with corresponding Bluetooth™-enabled devices. In one embodiment, the first transceiver 110 may be used to establish a communication link with a cellular-capable device so as to enable the headset 100 to be used for cellular communications initiated by a connected device.

Headset 100 further includes a microphone 140 and a first loudspeaker 150, both coupled to an optional voice processor 160 which communicates with the controller 130. In another embodiment, the microphone 140 and loudspeaker 150 communicate directly with the controller 130. The loudspeaker 150 may be in the form of an integrated earbud which extends into or against a user's inner ear when the headset 100 is configured as an earpiece. An optional second loudspeaker 170 is further depicted as being coupled to the voice processor 160, but may alternatively be coupled directly to the controller 130. In one embodiment, this second loudspeaker 170 may be configured as a retractable earbud usable for placing in the user's other ear (i.e., the ear opposite the headset 100). In this fashion, a user can conveniently be provided with dual-ear audio (i.e., music or voice) in a single compact design.

Memory 180 may contain processor-executable instruction sequences for operating the headset 100. The controller 130 may communicate with memory 180 via an address/data bus. It should be appreciated that the controller 130 may be any commercially available microcontroller or custom microprocessor. The memory 180 may include one or more read-only memories (ROM), erasable programmable ROMs (EPROM or Flash EPROM), battery backed random access memory (RAM), magnetic, optical, or other digital storage device, and may be separate from, or at least partially integral with the processor 130.

User controls 190 may be configured to enable various user inputs for accessing headset functions and for operating the headset 100 in general. It should be appreciated that user controls 190 may include buttons and/or switches relating to volume control, power control, menu access, music play/fast forward/rewind, etc. While not shown, it should further be appreciated that the headset 100 may include any or all additional components commonly found in wireless headset designs, such as a vibration motor, power source, LCD, LEDs, etc.

In one embodiment, headset 100 is a Bluetooth™-enabled earpiece which permits a user to communicate with another electronic device, such as a cellular telephone, PDA, etc. As will be discussed in more detail below, the headset 100 may be activated and operated using user controls 190. As is known in the art, the headset 100 may then be “paired” with or otherwise authenticated by one or more other communication devices (e.g., cellular telephone, PDA, etc.) using the first transceiver 110. In another embodiment, the headset 100 is further configured to receive a media data stream (e.g., music) from the user device 210 over the communication link 225. Music streaming may be temporarily halted to accommodate an incoming call. In one embodiment, the user device 210 may provide an incoming call signal to the headset 100 indicating a calling party is attempting to reach the user. Once the call is terminated, the music streaming may resume.

FIG. 1B depicts a perspective view of one embodiment of the headset 100 of FIG. 1A. As shown, headset 100 includes the loudspeaker 150 in the form of an earbud. Loudspeaker 170 is depicted as being a retractable earbud which a user can extend and place in the ear opposite the side the headset 100 is on. In addition, user controls 190 include various buttons for controlling music playback, accessing a menu, etc. Similarly, FIG. 1C depicts another view of the headset 100 of FIG. 1B in which the second loudspeaker/earbud 170 is housed within enclosure 195.

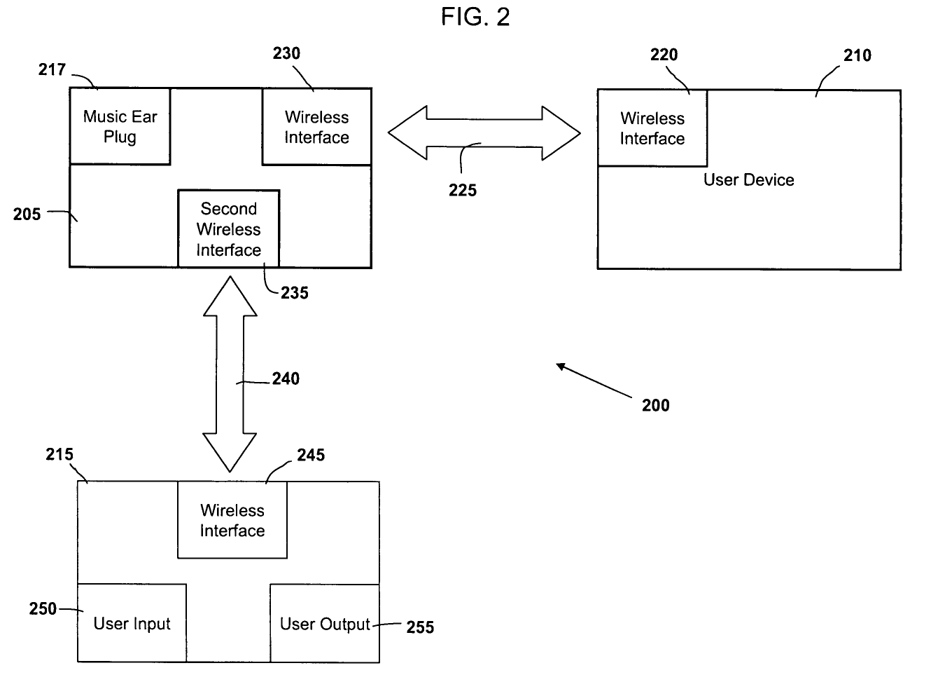

Referring now to FIG. 2, depicted is one embodiment of a communication system 200 which includes a wireless headset 205, a user device 210 and a wireless dialer 215. In one embodiment, the wireless headset is 205 is one embodiment of the headset 100 of FIGS. 1A-1B. To that end, although not shown, wireless headset 205 may further include one or more of the components described above with reference to FIG. 1A (e.g., microphone 140, loudspeakers 150, memory 180, user controls 190, etc.). The music ear plug 217 may be one embodiment of the second loudspeaker 170 depicted in FIGS. 1A-1B.

In certain embodiments, the user device 210 may be any personal electronic device (e.g., cellular phone, PDA, laptop, or other cellular-capable device) capable of wireless communication (e.g., Bluetooth™). In addition, user device 210 may be any cellular-capable device so as to enable headset 205 to be used as a communication device for cellular communication initiated by the user device 210.

User device 210 includes a wireless interface 220 for establishing a wireless communication link 225 to a corresponding wireless interface 230 of the wireless headset 205. In one embodiment, wireless interfaces 220 and 230 function as Bluetooth™ modules and communication link 225 is a Bluetooth™ connection. However, in alternate embodiments wireless interfaces 220 and 230 may enable any other form of RF communication.

As also shown, headset 205 is equipped with a second wireless interface 235. In one embodiment, this second wireless interface 235 is configured to establish a second communication link 240 with a corresponding wireless interface 245 of the wireless dialer 215. While in one embodiment the second communication link 240 may also be any RF-based signal, in another embodiment it may include an infrared-based signal.

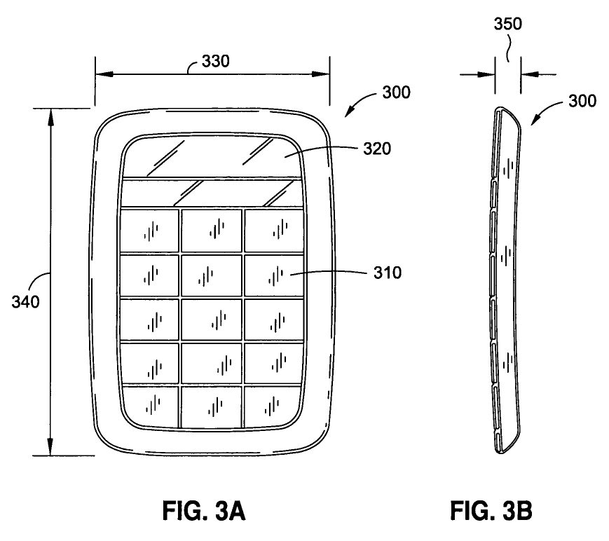

As will be described in more detail below with reference to FIGS. 3A-3B, in one embodiment the wireless dialer 215 may be a small and compact (e.g., credit card sized) device which includes a numeric keypad for entering a numeric sequence. The wireless dialer may be configured to enable a user to enter a telephone number using the user input 250 (e.g., keypad), and to transmit data representative of this telephone number to the headset 205 via communication link 240. Thereafter, the headset 205 may transmit the data to the user device 210 via communication link 225, which in turn uses the telephone number information to initiate a cellular telephone call. In this fashion, the wireless dialer 215 enables a user to use a conveniently small and compact device to wireless place a telephone call using a cellular-capable device (e.g., user device 210) which may not be as small or as conveniently located. User's would be free to leave their PDAs, smartphones, etc. in a stored location, and still be able to place a call via the wireless dialer 215 using only a credit-card sized keypad. Once the call is established, the headset 205 would enable handsfree two-way cellular communication.

FIG. 3A illustrates one embodiment of the wireless dialer 215 of FIG. 2. In this embodiment, wireless dialer 300 includes a keypad area 310 and a display 320. As previously mentioned, the wireless dialer 300 may be configured to enable a user to enter a telephone number using the keypad 310 and to transmit data representative of this telephone number to an corresponding headset (e.g., headset 205) via a communication link, such as an RF or infrared link. FIG. 3B depicts thin-form embodiment of the wireless dialer 300. In certain embodiments, the wireless dialer 300 may also be outfitted with music player functionality, including retractable headphones.

In certain embodiments, the dialer 215 may have a footprint of approximately the size of a business card. By way of example, the dialer 215 may have a width 330 of between 1 and 3 inches, and preferably about 2 inches. In addition, the dialer 215 may have a length 340 of between 1 and 5 inches, and preferable about 3 inches long. Finally, the dialer 215 may have a depth 350 of less than 1 inch, and preferably between 0.25 and 0.5 inches. It should be appreciated that in those embodiments where the dialer includes integrated music player functionality, the aforementioned dimensions may increase to accommodate the additional electrical components.

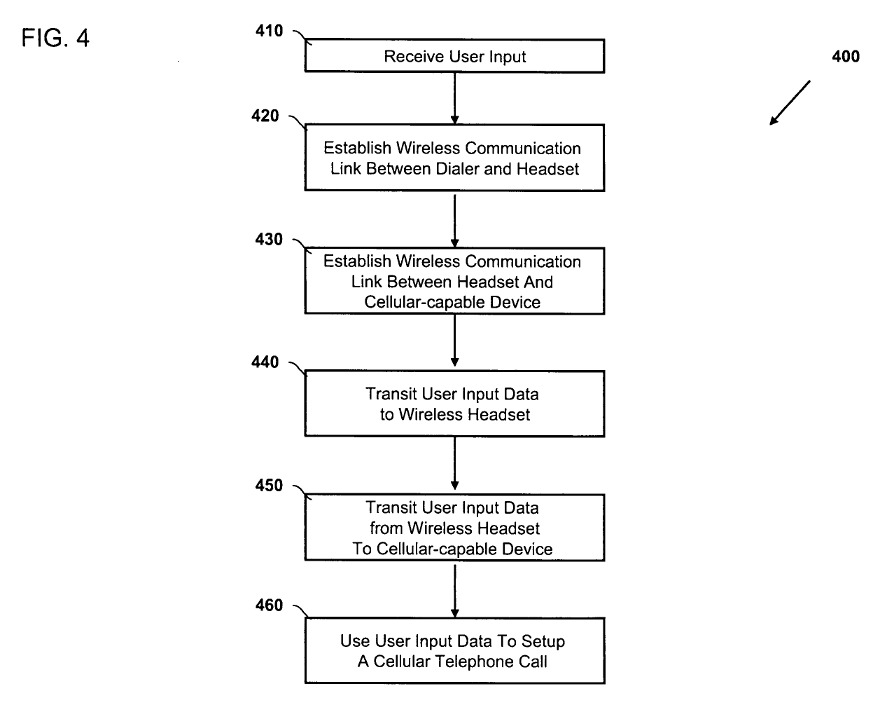

FIG. 4 is one embodiment of a flow diagram for a process of placing a telephone call in accordance with the principles of the invention. Process 400 assumes a cellular-capable device (e.g., user device 210) and a wireless headset (e.g., headset 205) have been “paired” or otherwise configured to recognize and accept communications from each other. Process 400 further assumes that the wireless headset has been configured receive a wireless communication (e.g., communication link 240) from a wireless dialer (e.g., dialer 215).

With that, process 400 begins at block 410 with the receiving of a user input. In one embodiment, the user input includes entering a telephone number via the wireless dialer. The user input of block 410 may be preceded by an activation request, such as pressing a power-on button. At block 420, a wireless communication link may then be established between the wireless dialer (e.g., dialer 215) and the wireless headset (e.g., headset 205) to which it has previously been “paired” or otherwise associated. As part of or in addition to the establishment of the communication link at block 420, a “wake up” signal may also be sent from the wireless dialer to the wireless headset. The “wake up” signal may be any known flag or other collection of bits usable to inform and/or prepare the headset for the fact that data is about to be transmitted to it. In systems where the headset is in a constant “ready-state” it may not be necessary to send such a “wake up” signal.

While in one embodiment, this communication link is an RF link, it may also be an infrared link. In certain embodiments, this communication link will be encrypted and/or require the user to perform an authentication operation (such as entering a passkey during a setup mode).

Similarly, a second wireless communication link may also then be established between the headset and the cellular-capable device (e.g., user device 210) at block 430. As previously mentioned, where both the headset and cellular-capable device are Bluetooth™-enabled, this link may be a Bluetooth™ connection, but may similarly be any other form of wireless connection. In another embodiment, the establishment of the communication link at block 430 may include or be preceded by a “wake up” signal sent from the wireless headset to the cellular-capable device. As with the previously discussed “wake up” signal, this signal may be any known flag or other collection of bits usable to inform and/or prepare the cellular-capable device that data is about to be transmitted to it. The “wake up” signal may be a signal generated by the dialer which is relayed by the headset, or it may be generated by the headset itself.

Process 400 continues to block 440 where the data representative of the previously-entered user input is transmitted from the wireless dialer to the wireless headset via the connection established at block 420. In another embodiment, it should be appreciated that the operation of block 440 may precede the operation of block 430.

Once the user input data has been provided to the wireless headset, process 400 continues to block 450 where this data may in turn be provided to the cellular-capable device via the connection established above at block 440. Thereafter, the cellular-capable device may use the user input data received to place a cellular telephone call to the intended called party.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A system for wireless communication comprising:
a cellular-capable device;
a wireless headset configured to establish a first wireless connection with the cellular-capable device; and
a wireless dialer configured to receive user communication data and to establish a second wireless connection with the wireless headset,
wherein the user communication data is to be transmitted from the wireless dialer to the wireless headset using the second wireless connection, and transmitted to the cellular-capable device from the wireless headset using the first wireless connection.

2. The system of claim 1, wherein the cellular-capable device is one of a cellular telephone, smartphone, personal digital assistant and a cellular-capable computer.

3. The system of claim 1, wherein the first wireless connection is a radio frequency connection established using an authentication operation.

4. The system of claim 1, wherein the authentication operation comprises a passkey sharing operation.

5. The system of claim 1, wherein the wireless headset is a single-ear headset and includes a first earbud for positioning adjacent to a first user ear.

6. The system of claim 5, wherein the wireless headset further includes a second earbud affixed to the headset on a retractable connection line, said second earbud configured for positioning adjacent to a second user ear.

7. The system of claim 1, wherein the wireless dialer includes a display and a keypad for entering the user communication data.

8. The system of claim 1, wherein the user communication data includes a called party telephone number.

9. The system of claim 1, wherein the second wireless connection is one of a radio frequency communication link and an infrared communication link.

10. The system of claim 1, wherein the wireless headset is further configured to receive a media data stream from the cellular-capable device over the first wireless connection.

11. The system of claim 10, wherein the media data stream comprises a music stream.

12. The system of claim 10, wherein the wireless headset is further configured to halt said media data stream in response to an incoming call signal from the cellular-capable device.

13. A method of wireless communication comprising:
receiving user communication data;
establishing a first wireless connection between a wireless dialer and a wireless headset;
establishing a second wireless connection between the wireless headset and a cellular-capable device;
transmitted the user communication data from the wireless dialer to the wireless headset using the first wireless connection; and
transmitted the user communication data from the wireless headset to the cellular-capable device using the second wireless connection.

14. The method of claim 13, wherein establishing the second wireless connection comprises performing an authentication operation between the wireless headset and the cellular-capable device.

15. The method of claim 14, wherein the authentication operation comprises sharing a passkey between the wireless headset and the cellular-capable device.

16. The method of claim 13, further comprising affixing an earbud to the wireless headset on a retractable connection line.

17. The method of claim 13, wherein receiving the user communication data comprises receiving the user communication data as a numeric input on a keypad of the wireless dialer.

18. The method of claim 17, wherein the user communication data includes a called party telephone number.

19. The method of claim 13, wherein establishing the first wireless connection comprises establishing one of a radio frequency communication link and an infrared communication link.

20. The method of claim 13, further comprising transmitting a media streaming from the cellular-capable device to the wireless headset over the second wireless connection.

21. The method of claim 20, further comprising halting the media stream in response to an incoming call signal sent from the cellular-capable device to the wireless headset.
